(19) United States
(12) Patent Application Publication
(10) Pub. No.: US 2023/0105658 A1
(43) Pub. Date: Apr. 6, 2023

(54) OOD DATA DETECTION APPARATUS, METHOD, AND STORAGE MEDIUM

(71) Applicant: KABUSHIKI KAISHA TOSHIBA, Tokyo (JP)

(72) Inventors: Kazuki UEMATSU, Fuchu Tokyo (JP); Kosuke HARUKI, Tachikawa Tokyo (JP); Mitsuhiro KIMURA, Fuchu Tokyo (JP); Hideyuki NAKAGAWA, Kawasaki Kanagawa (JP); Takahiro TAKIMOTO, Yokohama Kanagawa (JP)

(73) Assignee: KABUSHIKI KAISHA TOSHIBA, Tokyo (JP)

(21) Appl. No.: 17/931,891

(22) Filed: Sep. 13, 2022

(30) Foreign Application Priority Data
Oct. 6, 2021 (JP) 2021-164762
Jul. 26, 2022 (JP) 2022-118864

(51) Int. Cl. G06N 20/00

(52) U.S. Cl. CPC G06N 20/00

(57) ABSTRACT

An OOD data detection apparatus includes: an obtainment unit that obtains monitoring target data; an intermediate output calculation unit that calculates an intermediate output by applying a trained model to the monitoring target data; a projected-component calculation unit that calculates a projected component of the intermediate output to a parameter constituting the trained model; and a discrimination unit that discriminates as to whether the monitoring target data is OOD data based on the projected component.

### CROSS-REFERENCE TO RELATED APPLICATIONS

This application is based upon and claims the benefit of priority from Japanese Patent Application No. 2021-164762, filed Oct. 6, 2021, and No. 2022-118864, filed Jul. 26, 2022, the entire contents of all of which are incorporated herein by reference.

### FIELD

Embodiments described herein relate generally to an OOD data detection apparatus, method and storage medium.

### BACKGROUND

The performance of machine learning greatly depends not only on the model used but also on a data set during learning and a data set during operation. For example, in a case where a change occurs in the input data distribution depending on the operation state of the system, the trained model cannot exhibit the performance originally expected due to the difference in the data set, and performance deterioration thus advances as the input data distribution changes from the training data distribution with the passage of time. In particular, in the case of a deep learning model rapidly applied in recent years, it has been reported that even a data set comprised of out-of-distribution (OOD) data completely different from training data nevertheless exhibits behavior close in appearance to that of training data. For example, in a deep neural network (DNN) model that has learned a classification task, it has been reported that a classification probability for OOD data into each class should be low, but what is actually obtained is a classification probability high enough not to be significantly different from training data, thus rendering it difficult to detect OOD data.

Approaches for obtaining more accurate OOD detection performance have been made from various perspectives. In Non-patent Literature 1, intermediate outputs, outputs from each intermediate layer of a model, given by training data are approximated by a Gaussian distribution, and OOD detection is performed using a Mahalanobis distance from each class center of intermediate outputs as an index.

### BRIEF DESCRIPTION OF THE DRAWINGS

FIG. 1 is a diagram showing a configuration example of an OOD data detection apparatus according to a present embodiment.

FIG. 2 is a diagram showing a configuration example of a noise influence evaluation unit according to an aspect of evaluating a noise influence level by injecting a noise.

FIG. 3 is a diagram showing a configuration example of a noise influence evaluation unit according to an aspect of evaluating a noise influence level by calculating a projected component.

FIG. 4 is a diagram schematically showing OOD data processing.

FIG. 5 is a diagram showing a processing example of the evaluation phase.

FIG. 6 is a diagram showing a relationship between a network structure of a trained model and an intermediate output.

FIG. 7 is a diagram showing the data processing of a noise influence evaluation unit according to an aspect of evaluating a noise influence level by injecting a noise.

FIG. 8 is a diagram schematically showing the data processing of a noise influence evaluation unit according to an aspect of evaluating a noise influence level by calculating a projected component.

FIG. 9 is a diagram showing a processing example of the preprocessing phase.

FIG. 10 is a diagram schematically showing OOD data detection processing according to a modification 1.

FIG. 11 is a diagram showing a relationship between a depth of a layer and a stable rank according to a modification 2.

FIG. 12 is a diagram showing a performance index value for each detection method of OOD data.

FIG. 13 is a diagram showing memory usage of a method using a Mahalanobis distance and a method according to the present embodiment.

### DETAILED DESCRIPTION

An OOD data detection apparatus includes: an obtainment unit that obtains monitoring target data; an intermediate output calculation unit that calculates an intermediate output by applying a trained model to the monitoring target data; a projected-component calculation unit that calculates a projected component of the intermediate output to a parameter constituting the trained model; and a discrimination unit that discriminates between whether or not the monitoring target data is OOD data based on the projected component.

In Non-patent Literature 1 (Kimin Lee, Kibok Lee, Honglak Lee, and Jinwoo Shin, “A Simple Unified Framework for Detecting Out-of-Distribution Samples and Adversarial Attacks,” in Proceedings of the 32nd Conference on Neural Information Processing Systems (NeurIPS 2018)), after performing preprocessing for approximating an intermediate output of training data by a multivariate normal distribution, a difference from a training data distribution is evaluated based on a Mahalanobis distance. The computation of the Mahalanobis distance requires a mean vector and a covariance matrix, but the memory cost required for securing the mean vector and the covariance matrix is proportional to the square of the dimension of the feature map, so that a non-negligible amount of computational resources is required. Further, when we use a model that has learned a class classification task or use a network structure with convolution layers, individual evaluation in each class or an increase in the number of dimensions according to a convolution kernel receptive field occurs. The increase in computational cost resulting from the details of these tasks is secondary, but cannot be ignored because the increase itself can be as much as 10 to 100 times. Therefore, it is important to reduce the computational cost through an evaluation which is less dependent on the details of the task and more enhanced in the general-purpose aspect.

The problem to be solved by the present embodiment is to provide an OOD data detection apparatus, method and storage medium capable of detecting OOD data with a low memory capacity.

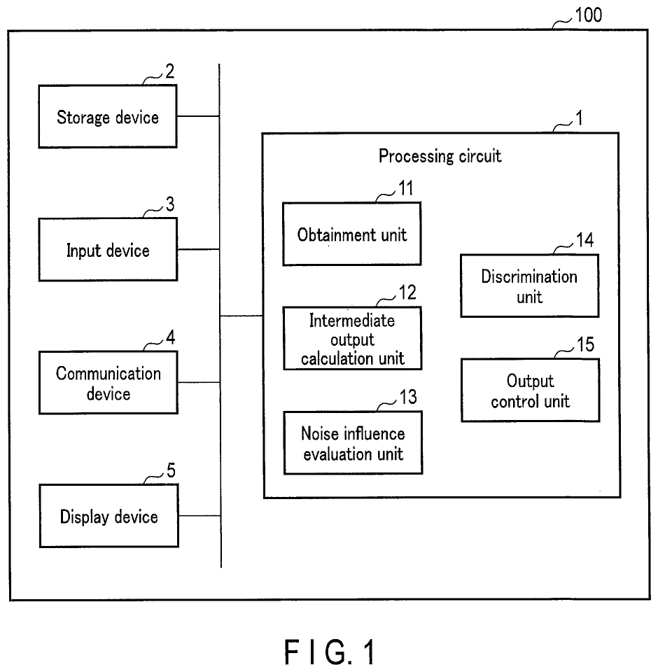

FIG. 1 is a diagram showing a configuration example of an OOD data detection apparatus 100 according to the present embodiment. As shown in FIG. 1, the OOD data detection apparatus 100 is a computer including a processing circuit 1, a storage device 2, an input device 3, a communication device 4, and a display device 5. Data communication among the processing circuit 1, the storage device 2, the input device 3, the communication device 4, and the display device 5 is performed via a bus.

The processing circuit 1 includes a processor such as a central processing unit (CPU) and a memory such as a random access memory (RAM). The processing circuit 1 includes an obtainment unit 11, an intermediate output calculation unit 12, a noise influence evaluation unit 13, discrimination unit 14, and an output control unit 15. The processing circuit 1 realizes the functions of the above units 11 to 15 by executing the OOD data detection program. The OOD data detection program is stored in a non-transitory computer-readable storage medium such as the storage device 2. The OOD data detection program may be implemented either as a single program describing all the functions of the above units 11 to 15 or as a plurality of modules divided into several functional units. The above units 11 to 15 may be implemented by an integrated circuit such as an application specific integrated circuit (ASIC). In this case, the units may be either implemented in a single integrated circuit or individually implemented in a plurality of integrated circuits.

The obtainment unit 11 obtains a trained model. The trained model is a deep learning model whose parameter has been trained to perform any task. The task of the trained model is not particularly limited, and a regression problem, a classification problem, or any other task may be executed. The network structure of the trained model is also not particularly limited. The obtainment unit 11 obtains monitoring target data. The monitoring target data is data to be discriminated as to whether or not the data is OOD data. The type and format of the data are not particularly limited and may be any type and format as long as the data can be input to the trained model. The OOD data according to the present embodiment means data statistically distinguishable from the data used for training the trained model.

The intermediate output calculation unit 12 calculates an intermediate output by applying the trained model obtained by the obtainment unit 11 to the monitoring target data obtained by the obtainment unit 11. The intermediate output is an output of a hidden layer before the output layer of the trained model.

The noise influence evaluation unit 13 calculates a degree of influence upon a parameter constituting the trained model obtained by the obtainment unit 11 in the case where a noise is injected into an intermediate output calculated by the intermediate output calculation unit 12. Specifically, the noise influence evaluation unit 13 calculates a variation of an output at a latter hidden layer originated from a minute noise injection into the previous intermediate output calculated by the intermediate output calculation unit 12. The noise influence evaluation unit 13 according to the present embodiment has an aspect of evaluating a noise influence level by injecting a noise and by calculating a projected component.

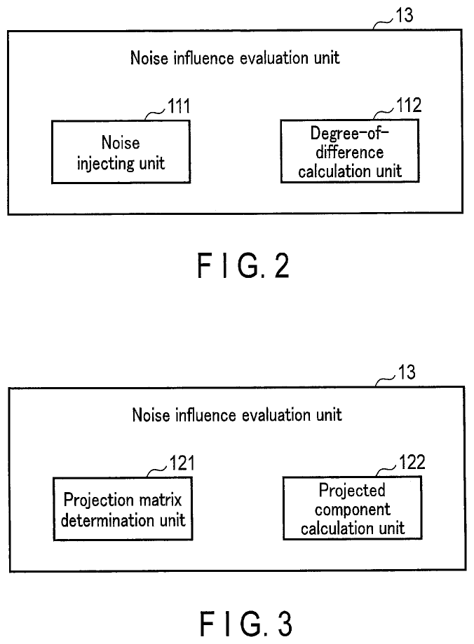

FIG. 2 is a diagram showing a configuration example of the noise influence evaluation unit 13 according to an aspect of evaluating a noise influence level by injecting a noise. As shown in FIG. 2, the noise influence evaluation unit 13 has a noise injecting unit 111 and a degree-of-variation calculation unit 112. The noise injecting unit 111 injects a noise to an intermediate output in an intermediate hidden layer of a trained model. The degree-of-variation calculation unit 112 first calculates an intermediate output by passing the noise-uninjected intermediate output through following hidden layers. The degree-of-variation calculation unit 112 next calculates another intermediate output by passing the noise-injected intermediate output through following hidden layers. Subsequently, the degree-of-variation calculation unit 112 calculates a degree of variation between these intermediate outputs.

FIG. 3 is a diagram showing a configuration example of the noise influence evaluation unit 13 according to an aspect of evaluating a noise influence level by calculating a projected component. As shown in FIG. 3, the noise influence evaluation unit 13 has a projection matrix determination unit 121 and a projection matrix calculation unit 122. The projection matrix determination unit 121 determines a projection matrix based on a matrix decomposition of a parameter constituting the trained model. The projected-component calculation unit 122 calculates, as a noise influence level, a projected component of the intermediate output to a parameter constituting the trained model. More specifically, the projected-component calculation unit 122 calculates a projected component by making the projection matrix determined by the projection matrix determination unit 121 act on the intermediate output.

The discrimination unit 14 discriminates as to whether the monitoring target data obtained by the obtainment unit 11 is OOD data based on the noise influence level calculated by the noise influence evaluation unit 13.

The output control unit 15 outputs a discrimination result by the discrimination unit 14 as to, whether or not the monitoring target data is OOD data. The discrimination result may be displayed on the display device 5, stored in the storage device 2, or transmitted to another computer via the communication device 4. The output control unit 15 may display any other information on the display device 5 or others.

The storage device 2 is configured by a read only memory (ROM), a hard disk drive (HDD), a solid state drive (SSD), or an integrated circuit storage device, for example. The storage device 2 stores monitoring target data, a trained model, and an OOD data detection program, for example.

The input device 3 inputs various commands from a user. As the input device 3, a keyboard, a mouse, various switches, a touch pad, or a touch panel display, for example, can be used. An output signal from the input device 3 is supplied to the processing circuit 1. Note that the input device 3 may be an input device of a computer connected to the processing circuit 1 via a wire or wirelessly.

The communication device 4 is an interface for performing data communication with an external device connected to the OOD data detection apparatus 100 via a network.

The display device 5 displays various kinds of information. For example, the display device 5 displays the structure-performance relationship data under the control of the output control unit 16. As the display device 5, a cathode-ray Tube (CRT) display, a liquid crystal display, an organic electro luminescence (EL) display, a light-emitting diode (LED) display, a plasma display, or any other display known in the art can be appropriately used. The display device 5 may be a projector.

The OOD data detection apparatus 100 according to the present embodiment will be described below in detail.

In the processing by the OOD data detection apparatus 100, whether monitoring data is OOD data based on the noise influence level is discriminated in the evaluation phase.

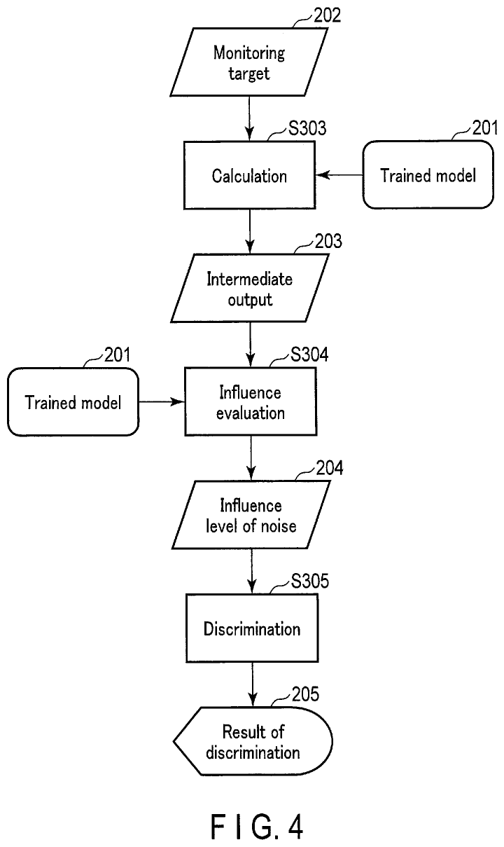

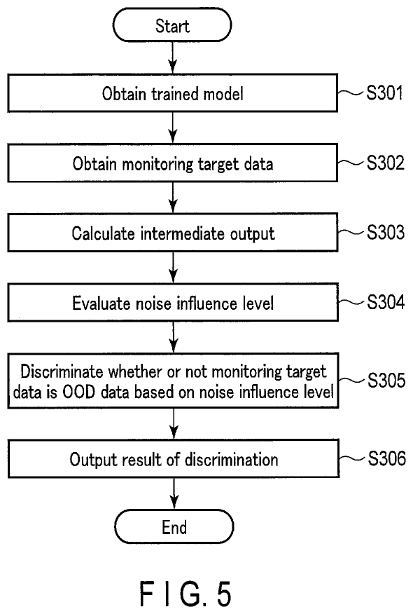

FIG. 4 is a diagram schematically showing the OOD data processing. FIG. 5 is a diagram showing the procedures of the OOD data processing. As shown in FIGS. 4 and 5, the obtainment unit 11 obtains a trained model 201 (step S301). In the trained model 201, learnable parameters are trained based on a plurality of pieces of training data. The learnable parameters include weight and bias parameters that describe an Affine transformation at a layer constituting the trained model 201. In the trained model 201, an activation function is assigned to each node or channel as a hyperparameter. As other hyperparameters, a size of a convolution kernel receptive field, a parameter of batch normalization and others are assigned.

The trained model 201 may be stored in the storage device 2 in advance. In this case, the obtainment unit 11 reads the trained model 201 from the storage device 2. As another example, the obtainment unit 11 may receive the trained model 201 from another computer via the communication device 4.

After step S301 is performed, the obtainment unit 11 obtains monitoring target data 202 (step S302). The monitoring target data 202 may be stored in the storage device 2 in advance. In this case, the obtainment unit 11 reads the monitoring target data 202 from the storage device 2. As another example, the obtainment unit 11 may receive the monitoring target data 202 from another computer via the communication device 4.

After step S302 is performed, the intermediate output calculation unit 12 calculates an intermediate output 203 by applying the monitoring target data 202 obtained in step S302 to the trained model 201 obtained in step S301 (step S303).

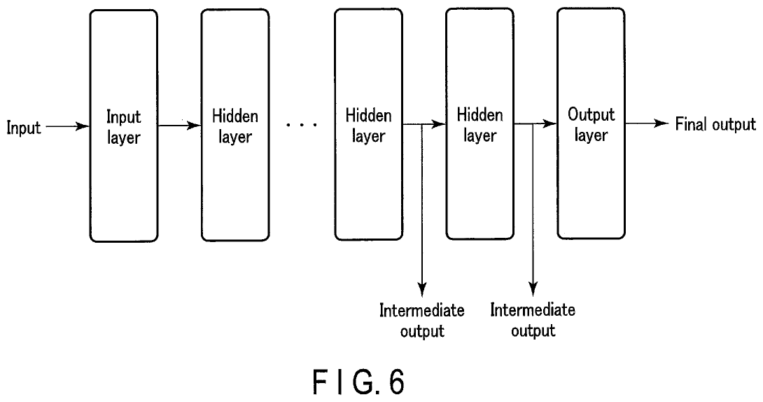

FIG. 6 is a diagram showing a relationship between a network structure of the trained model and intermediate outputs. As shown in FIG. 6, the trained model includes an input layer, some hidden layers, and an output layer. It suffices that there is at least one hidden layer. Data such as monitoring target data is given to the input layer. The output layer then provides a final output. The data format of the final output varies depending on the task of the trained model. For example, if the task of the trained model is a classification problem, the classification result, that is, the corresponding probability of each class, is the final output.

Some hidden layers are provided between the input layer and the output layer. Various types of hidden layers are available; for example, a convolutional layer, a fully connected layer, a batch normalization layer, and a pooling layer. The output of each hidden layer is an intermediate output. The output of the hidden layer is also referred to as a “feature vector”. The position of the hidden layer to obtain the intermediate output 203 is not particularly limited and can be arbitrarily set. Instead of the intermediate output of a single hidden layer, the concatenation of multiple intermediate outputs from multiple hidden layers may be used as the intermediate output 203.

After step S303 is performed, the noise influence evaluation unit 13 calculates a noise influence level 205 to the intermediate output 203 calculated in step S303 (step S304).

There are a few methods to calculate a noise influence level. One is the method shown in FIG. 2 by the noise influence evaluation unit 13, and another is the method shown in FIG. 3 by the noise influence evaluation unit 13.

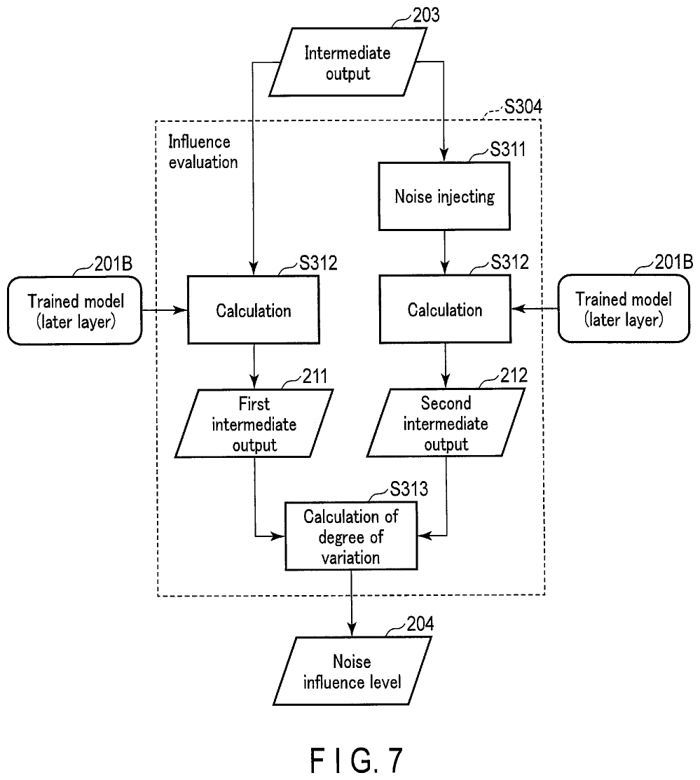

FIG. 7 is a diagram showing the procedures for calculating a noise influence level by the noise influence evaluation unit 13 shown in FIG. 2. As shown in FIG. 7, the intermediate output 203 is calculated in step S303 from intermediate hidden layers of the trained model 201. The degree-of-variation calculation unit 112 calculates a first intermediate output 211 by passing the noise-uninjected intermediate output 203 through following hidden layers 201B in the trained model 201 (step S312). Simultaneously, the noise injecting unit 111 directly injects a minute noise to the intermediate output 203 (step S311). Next, the degree-of-variation calculation unit 112 calculates the second intermediate output 212 by passing the noise-injected intermediate output through following hidden layers 201B (step S312). Then, the degree-of-variation calculation unit 112 calculates a degree of variation in the first intermediate output 211 and the second intermediate output 212 as a noise influence level. As the degree of variation, a difference between the first intermediate output 211 and the second intermediate output 212 may be calculated. The degree of variation is not limited to a difference between the first intermediate output 211 and the second intermediate 212; an arbitrary value or function may be added to the difference, or a ratio of the second intermediate output 212 to the first intermediate output 211 may be calculated.

The degree of variation ψ may be calculated based on the following expression. The symbols “l” and “m” represent hidden layers. The hidden layer l represents a hidden layer to which the intermediate output 203 is output. The hidden layer m represents a hidden layer to which the first intermediate output 211 and the second intermediate output 212 are output. xₗ represents an intermediate output 203 given by hidden layers before the l-th layer. η is a noise to be injected to xₗ. M^{lm}(xₗ) represents a first intermediate output 211 that is output from the hidden layer m when an intermediate layer xₗ is input to the hidden layer l. M^{lm}(xₗ+η∥xₗ∥) is a second intermediate output 212 that is output from the hidden layer m when a noise η-injected intermediate output xₗη∥xₗ∥ is input to the hidden layer l.

$$ψ ( {x}_{l} , η ; {M}^{l m} ) = \frac{{‖ {M}^{l m} ( {x}_{l} + η ‖ {x}_{l} ‖ ) - {M}^{l m} ( {x}_{l} ) ‖}^{2}}{{‖ {M}^{l m} ( {x}_{l} ) ‖}^{2}} ‖ η ‖ = 0. 1$$

There may be one or more layers of hidden layers. The noise to be injected may be a noise generated from isotropic probability distribution or anisotropic probability distribution, an intermediate output 204 given by training data, or an intermediate output 204 given by accessible public data. Many intermediate outputs 212 may be obtained by performing steps S311 and S312 for many times, in which a noise is injected and an influence thereof is calculated, and a variation between the intermediate outputs 212 and the intermediate output 211 may be calculated in step S313. Since noise injection does not require any memory cost, this is a memory-saving method. When a noise is injected for many times, on the other hand, a calculation time increases.

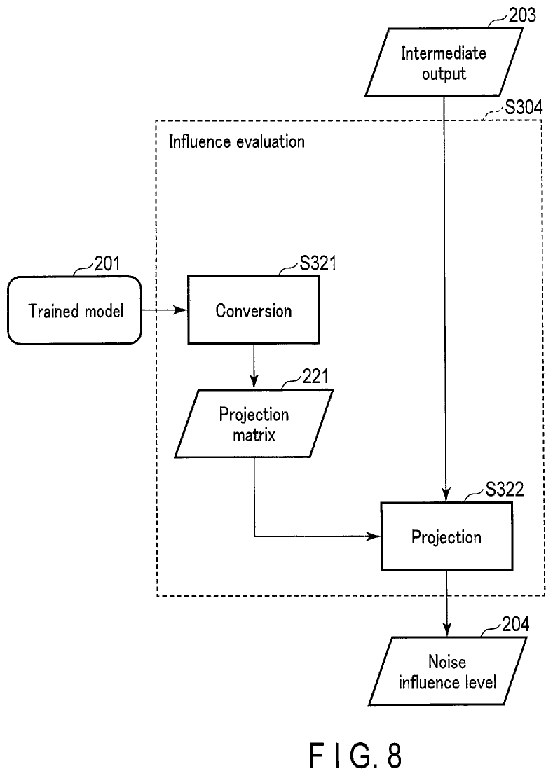

FIG. 8 is a diagram showing the procedures of calculating a noise influence level by the noise influence evaluation unit 13 shown in FIG. 3. As shown in FIG. 8, as a level of noise influence against the intermediate output 203, a projected component corresponding to a degree of how the parameter of the trained model 201 matches the intermediate output 203 may be used. The projected component may be calculated for a single layer or multiple layers, similarly to the case of the direct calculation of a noise influence level.

In this case, the projection matrix determination unit 121 converts the parameters constituting the trained model 201 into the projection matrix 221 (step S321). In step S321, the projection matrix determination unit 121 performs matrix decomposition on the weight parameter constituting the trained model 201 to calculate the projection matrix 221. Next, the projected-component calculation unit 122 makes the projection matrix 221 act on the intermediate output 203 to calculate a noise influence level 204 (step S322).

The meaning of the projection of the intermediate output 203 onto the parameters of the trained model 201 will now be described. In principle, when input data x is equivalent to the training data, it can be said that the projected component of the intermediate output f onto the weight parameter W is large. (See Sanjeev Arora, Rong Ge, Behnam Neyshabur, and Yi Zhang, “Stronger Generalization Bounds for Deep Nets via a Compression Approach.” Proceedings of the 35th International Conference on Machine Learning, PMLR, vol. 80, pp. 254-263, 2018.) Therefore, when the projected component of the intermediate output f onto the weight parameter W is small, it can be said that the input data x is different from the training data, that is, the input data x is OOD data.

Furthermore, if the input data x is equivalent to training data, it has been demonstrated that the input data x is stable to the noise injection, and particularly for the weak noise injection, a projection-based evaluation is equivalent to an evaluation by a noise influence level. In order to theoretically and strictly calculate a noise influence level, it is necessary to inject a noise an infinite number of times. When projection-based evaluation is performed, on the other hand, it is possible to obtain a strict evaluation result without noise injection. In other words, it is possible to obtain highly reliable results from the projection-based evaluation in a short calculation time. On the other hand, since the calculation of a projected component requires a projection matrix of the kind described later, a required memory cost may increase in some cases.

The projected component over multiple layers may be calculated by linear approximation of an m-th layer intermediate output with an l-th layer intermediate output. Via the linear approximation, a feature vector obtained from an m-th layer is given by a linear transformation of a feature vector obtained from an l-th layer. The matrix representing this linear transformation can be uniquely determined if the parameters of the trained model 201 and the intermediate output 203 are given. A projection matrix 221 can be calculated by performing matrix decomposition on the obtained matrix. In other words, the projection matrix 221 can be calculated by decomposing a matrix obtained by linear approximation (step S321). By making the projection matrix 221 act on the intermediate output 203, a projected component corresponding to a noise influence level, namely the noise influence level 204, can be calculated. The calculation of a noise influence level based on projection may be conducted in the above-described manner.

The method of matrix decomposition is not particularly limited, and singular value decomposition (SVD), non-negative matrix factorization (NMF) or others can be used. In the present embodiment, singular value decomposition is assumed to be used as matrix decomposition for the purpose of an example.

As mentioned above, a projected component may be calculated over multiple layers, but a projected component of a single layer may also be calculated as a noise influence level 204. In this case, only a weight parameter is used as a parameter targeted for conversion into the projection matrix 221. The weight parameter is converted into a matrix by aligning the weight parameter for each layer in accordance with a predetermined rule. For example, the fully-connected weight parameter between the i-th layer and the (i+1)-th layer is converted into a matrix with Cᵢ₊₁×Cᵢ components, where the number of row components Cᵢ is the number of channels at the i-th layer and the number of column components Cᵢ₊₁ is the number of channels at the (i+1)-th layer. For another example, the convolution type weight parameter between the i-th layer and the (i+1)-th layer is converted into a matrix with (Cᵢ×Fᵢ)×Cᵢ₊ₗ components, where Fᵢ is the spatial size of the receptive field of the convolution kernel at the i-th layer.

If the calculation of the noise influence level 204 is conducted using projection, the noise influence evaluation unit 13 calculates a noise influence level 204 based on a projection matrix obtained by performing matrix decomposition on a weight parameter constituting the trained model 201. If singular value decomposition is used, singular value decomposition is performed on a weight parameter W to convert it to USV^{T}. The weight parameter W is a matrix configured by the above-described method and through defining the conversion rules of the intermediate output 204 over a single layer or multiple layers. U is a matrix of left singular vectors, V is a matrix of right singular vectors, and S is a diagonal matrix of singular values. T represents transposition. The projection matrix 202 is V^{T} and means a matrix representing a projection onto the weight parameter W.

As described above, the projection matrix 221 is a right singular vector V^{T} when the weight parameter W is converted into USV^{T} using singular value decomposition. Specifically, the layer index l before projection and the layer index m after projection are designated prior to the weight parameter W^{(lm)} being calculated. Herein, l and m satisfy 1≤l<m≤L. L is a natural number greater than or equal to 1. Next, singular value decomposition is performed on W^{(lm)} to convert it to U^{(lm)}S^{(lm)}V^{(lm)T}. A concatenation of projection matrices obtained through various l and m, V^{(12)T}, V^{(13)T}, . . . , V^{(L-2,L-1)T}, and V^{(L-1,L)T}, may be used as a projection matrix V^{T}. The projected-component calculation unit 122 calculates a projected component fₚ=V^{T}f by making the projection matrix V^{T} act on an intermediate output f. Since the projection matrix V^{T} is a orthonormal basis of the weight parameter W, the projected component fₚ means the projection of the intermediate output f in the direction of the principal component of the weight parameter W.

After step S304 is performed, the discrimination unit 14 discriminates as to whether the monitoring target data 202 obtained in step S302 is OOD data based on the noise influence level 204 calculated in step S304 (step S305). In step S305, a discrimination result 205 is output as to whether or not the monitoring target data 202 is OOD data.

Various methods can be used to discriminate OOD data. As an example, the intermediate output calculation unit 12 calculates an intermediate output by applying each set of training data to the trained model 201, and the noise influence evaluation unit 13 calculates an influence of noise to each intermediate output. The discrimination unit 14 plots a point corresponding to an influence of noise on each training data (hereinafter referred to as a “training data point”) in a space defined by the noise influence (hereinafter referred to as a “noise influence space”), and specifies a cluster of the training data points. The discrimination unit 14 then plots a point corresponding to the noise influence 204 of the monitoring target data 202 (hereinafter referred to as a “monitoring target point”) in the noise influence space, and discriminates as to whether the monitoring target point belongs to a cluster. For example, the discrimination unit 14 discriminates that the monitoring target data 202 is OOD data when the monitoring target point is not included in the cluster, and discriminates that the monitoring target data 202 is not OOD data when the monitoring target point is included in the cluster. As another example, the discrimination unit 14 may determine a representative point of a cluster. After that, the discrimination unit 14 may discriminate that the monitoring target data 202 is OOD data when a distance between the representative point and the monitoring target point is longer than a threshold, or discriminate that the monitoring target data 202 is not OOD data when the distance is shorter than the threshold. The representative point may be a center of the cluster, the closest training data point to the monitoring target point, or an average value of the training data points belonging to the cluster.

After step S305 is performed, the output control unit 15 outputs the discrimination result 205 as to whether or not the data is the OOD data generated in step S305 (step S306). The discrimination result 205 is displayed on the display device 5. For example, a message such as “the monitoring target data is OOD data” or “the monitoring target data is not OOD data” may be displayed as the discrimination result 205.

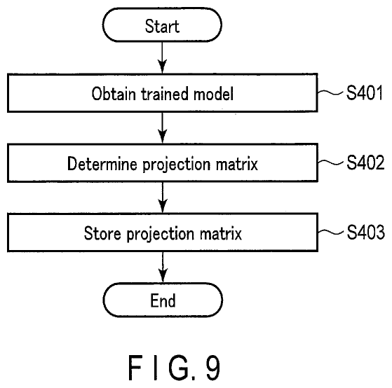

As described above, the OOD data detection processing related to the evaluation phase is completed. Note that the OOD data detection processing according to the present embodiment is not limited to the above processing example. For example, the order of the acquisition of the trained model (step S301) and the acquisition of the monitoring target data (step S302) may be reversed. When a noise influence is evaluated using projection, the determination of the projection matrix 221 may be performed at any stage as long as this stage comes before step S322 in which the projection is performed. For example, a preprocessing phase of FIG. 9 may be prepared before the evaluation phase of FIG. 5, and the projection matrix 221 may be calculated within this phase. In this case, the projection matrix 221 may be determined by another dedicated computer, and a calculation result may be stored in the storage device 2. Thus, the OOD data detection apparatus 100 can be realized in a calculation environment with limited resources such as an edge device. Since the noise influence evaluation through noise injection can be performed in a short time at a negligible memory cost as long as the number of noise injection is small, such an evaluation is available under a calculation environment where resources are much more limited than one in which projection-based evaluation is performed.

The OOD data detection processing according to the present embodiment can be rendered possible in the various modifications described below.

### Modification 1

The discrimination unit 14 according to a modification 1 discriminates OOD data based on a variable for discrimination instead of a noise influence level itself.

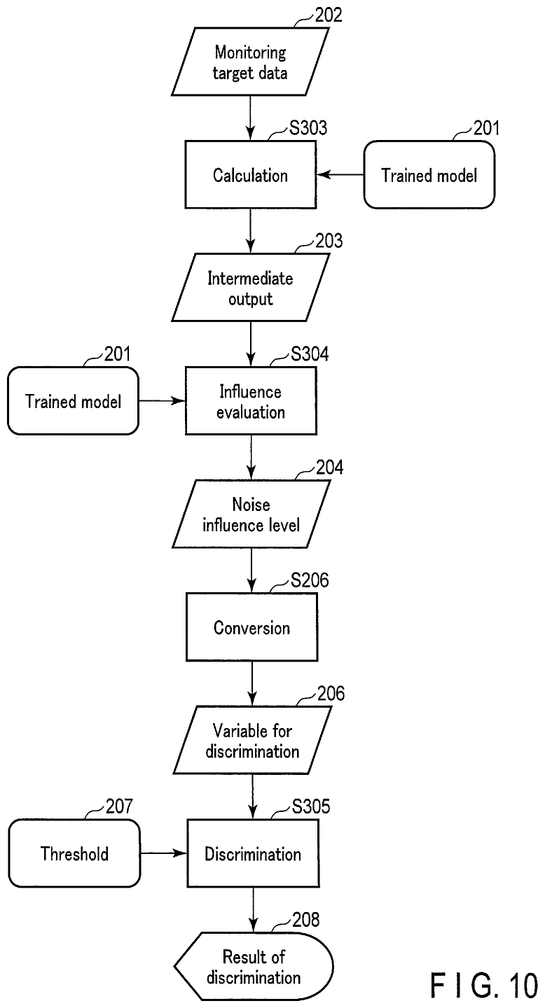

FIG. 10 is a diagram schematically showing the OOD data detection processing according to the modification 1. Note that, in the following description, elements substantially the same as those in FIG. 4 are denoted by the same reference numerals, and will be repeatedly described only when necessary.

As shown in FIG. 10, if the noise influence level 204 from the projection matrix 203 is calculated from the intermediate output 204 of the monitoring target data 202, the discrimination unit 14 converts the noise influence level 204 into a one-dimensional variable for discrimination 206 (step S601). The variable for discrimination 206 may be any variable as long as that variable is a one-dimensional variable based on the noise influence level 204. As the variable for discrimination 206, a norm of a difference between intermediate outputs given by noise-injected and noise-uninjected intermediate outputs, a ratio between a norm of the difference and a norm of an intermediate output given by a noise-uninjected intermediate output, a norm of a projected component after making a projection matrix act thereon, or a ratio between a norm after projection and a norm before projection may be used.

After step S601 is performed, the discrimination unit 14 discriminates as to whether the monitoring target data 202 is OOD data based on a comparison between the variable for discrimination 206 obtained in step S206 and a preset threshold 207 (step S602). Specifically, the discrimination unit 14 compares the magnitudes of the variable for discrimination 206 and the threshold 207, discriminates that the monitoring target data 202 is not OOD data when the variable for discrimination 206 is larger than the threshold 207, and discriminates that the monitoring target data 202 is OOD data when the variable for discrimination 206 is smaller than the threshold 207. A discrimination result 208, indicating whether or not the monitoring target data 202 is OOD data, is output to the display device 5 or others by the output control unit 15.

The threshold 207 is set to a value capable of identifying between the variable for discrimination based on the training data and the variable for discrimination based on the OOD data. The threshold 207 may be set through the following steps in the preprocessing phase or the evaluation phase. For example, the discrimination unit 14 firstly selects OOD data from collected data to set a threshold, not to re-train a trained model. A selection criterion is not particularly limited, but, for example, data having statistically distinguishable properties from the training data when converted into a variable for discrimination may be selected as OOD data. For another example, when the task to be solved is multi-class classification, data belonging to a specific class may be set to the OOD data while the rest may be set to the training data. The number of specific classes is not particularly limited, but may be several, such as one or two. After the model is trained based on the selected training data by a processing circuit 1 or others, for both of the OOD data and the training data, the intermediate output calculation unit 12 calculates an intermediate output, the noise influence evaluation unit 13 calculates a level of noise influence to an intermediate output, and the discrimination unit 14 converts the noise influence level into a variable for discrimination. The discrimination unit 14 then searches for a value capable of identifying between the variables for discrimination given by the OOD and training data, and sets the value to the threshold 207. Thus, the threshold 207 capable for detecting OOD data can be set.

The division into training and OOD data may not be performed to set the threshold. In this case, the discrimination unit 14 sets the threshold 207 so that a statistical outlier among the data used for training the model 201 can be classified as OOD data. Specifically, the discrimination unit 14 first specifies an outlier from training data by an arbitrary test. The discrimination unit 14 then searches for a value capable of identifying between the variables for discrimination given by the outlier and other training data, and sets the searched value to the threshold 207. Thus, the threshold 207 capable of detecting an outlier can be set.

### Modification 2

In the above example, particularly when a noise influence level is evaluated by projection, all components included in the projection matrix has been assumed to be used. However, the present embodiment is not limited thereto. The projection matrix determination unit 121 according to a modification 2 changes the position and/or the number of matrix components included in the projection matrix. The position of a matrix component is defined by the row number and column number of the matrix component. The number of matrix components included in the projection matrix is determined independent of the position of the matrix component.

As described above, the projection matrix V^{T} is a concatenation of V^{(12)T}, V^{(13)T}, . . . , V^{(L-2, L-1)T} and V^{(L-1, L)T}. For example, the projection matrix V^{T} is generated by arranging V^{(12)T}, V^{(13)T}, . . . , V^{(L-2, L-1)T} and V^{(L-1, L)T} in order from the first row to the L-th row. The projection matrix determination unit 12 reduces the position and/or the number of matrix components included in the projection matrix by deleting a matrix component with less contribution to the task of the trained model. A matrix component with less contribution is, for example, a matrix component corresponding to a smaller singular value than a reference value. The reference value may be arbitrarily determined experimentally or empirically. The deletion of the matrix component may be either for setting the value of the matrix component to zero or deleting the matrix component itself.

As another example, the projection matrix determination unit 121 may search for the position and/or the number of matrix components based on the performance variation of the task. Specifically, the projection matrix determination unit 121 evaluates the performance of the task of the trained model while changing the position and/or the number of matrix components included in the projection matrix. The performance may be evaluated by an arbitrary performance index value, such as area under the receiver operating characteristic curve (AUROC) or area under the precision-recall curve (AUPR). The projection matrix determination unit 121 determines the position and/or the number of matrix components whose performance index values satisfy a predetermined condition. The predetermined condition is not particularly limited, but as an example, may be set to be optimal in terms of computational cost and/or performance. The projection matrix determination unit 121 specifies a matrix component corresponding to the position and/or the number when a predetermined condition is satisfied, and deletes matrix components other than the specified matrix component. The weight parameter corresponding to the deleted matrix component may be deleted from the trained model. Thus, the size of the trained model can be compressed by pruning the weight parameters that do not contribute to the task. As an example, when the task of the trained model is a classification task, if the position and the number of weight parameters are changed, the class inference probability (final output) and the classification performance are also changed. For example, a matrix component with less contribution to performance may be deleted from the projection matrix, and a corresponding weight parameter may be deleted from the trained model.

As described above, it is possible to further reduce the memory usage of the projection matrix while maintaining the detection performance of OOD data by deleting a matrix component having a low degree of contribution among the projection matrices. Note that the unnecessary weight parameter described above may be deleted from the trained model. Thus, it is possible to obtain a trained model with little memory usage while maintaining the same performance as before the deletion.

The deletion of unnecessary parameters from the trained model may be performed at the time when the noise influence level, not projection, takes the form of evaluation. Even in this case, it is possible to obtain a trained model with little memory usage while maintaining the same performance as before the deletion.

### Modification 3

In the above example, one threshold has been assumed to be set for the variable for discrimination. However, the present embodiment is not limited thereto. The discrimination unit 15 according to a modification 3 determines a threshold for each layer of the trained model, and discriminates as to whether the monitoring target data is OOD data based on a comparison between the variable for discrimination for each layer and the threshold. As an example, the discrimination unit 15 may determine the threshold based on the rank of the parameter matrix for each layer. More specifically, the discrimination unit 15 sets a threshold so as not to contribute to the discrimination of OOD data for a layer in which the rank of the parameter matrix for each layer is larger than the reference. On the other hand, the discrimination unit 15 sets a threshold in accordance with the above example so as to contribute to the discrimination of OOD data for a layer in which the rank is smaller than the reference. For the evaluation of the rank, the stable rank of the matrix, the squared ratio of the Frobenius norm ∥W∥_{F} to the spectral norm ∥W∥₂ of the matrix, ∥W∥_{F}_{²}/∥W∥₂_{²}, or a stable rank normalized by a matrix size may be used.

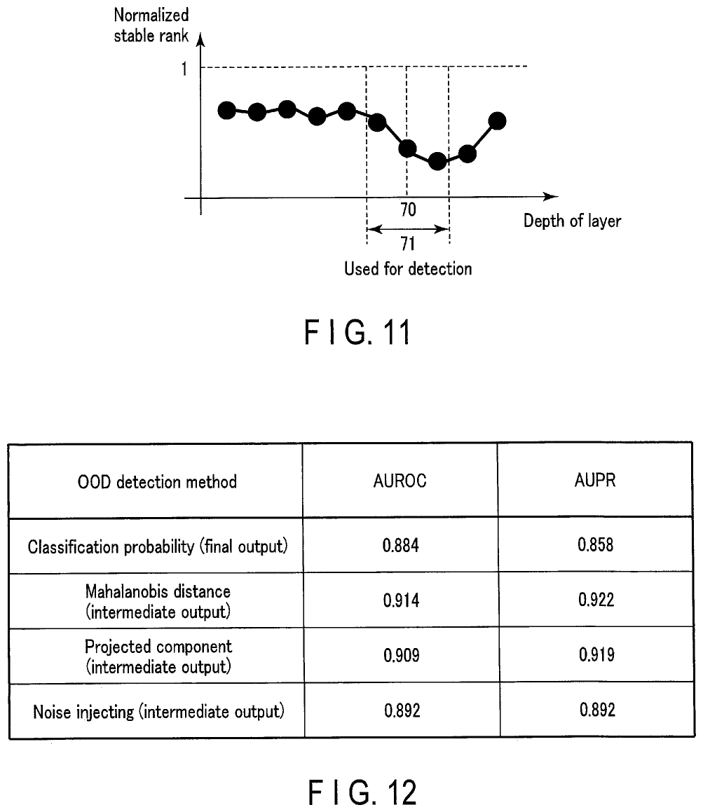

FIG. 11 is a diagram showing a relationship between a depth of a layer and a normalized stable rank. In FIG. 11, the vertical axis represents the normalized stable rank, and the horizontal axis represents the depth of the layer. The normalized stable rank takes a value from “1” to “0”. The full-rank matrix has the normalized stable rank value of “1” at maximum, while the low-rank matrix has the normalized stable rank value of “0” at minimum. The depth of layer means the number of layers from the input layer. The depth dependence of the normalized stable rank tends to be convex downward. At a layer with high OOD data detection performance, the normalized stable rank tends to rapidly decrease. Therefore, the discrimination unit 14 first calculates a normalized stable rank based on the rank of the weight parameter matrix for each layer. The discrimination unit 14 then specifies a layer 70 where the normalized stable rank decreases rapidly. The discrimination unit 14 then sets a range 71 of a predetermined number of layers including the layer 70 to detect OOD data (hereinafter, referred to as a “use range”). The predetermined number of layers in the use range 71 may be determined experimentally or empirically.

For layers other than the use range (hereinafter referred to as a “non-use range”), the discrimination unit 14 sets a threshold to a relatively small value such as zero so as not to contribute to the discrimination of OOD data. On the other hand, for the layer in the use range, the discrimination unit 14 sets a threshold in accordance with the above example so as to contribute to the discrimination of OOD data.

When a threshold is set for each layer, the discrimination unit 14 calculates a variable for discrimination for each layer, and discriminates as to whether the monitoring target data is OOD data based on a comparison between the variable for discrimination and the threshold for each layer. The discrimination unit 14 finally discriminates as to whether the monitoring target data is OOD data based on the discrimination result for each layer. For example, the discrimination unit 14 may determine the final discrimination result based on a majority of the discrimination results for each layer of the use range. Specifically, when the monitoring target data is determined to be OOD data by larger number of layers than half, the monitoring target data may be determined to be OOD data. On the other hand, when the monitoring target data is determined not to be OOD data by larger number of layers than half, the monitoring target data may be determined not to be OOD data. Setting a threshold for each layer allows for the placing of importance on the discrimination result of a layer having high performance of detecting OOD data. Thus, improved performance of detecting OOD data as a whole can be expected. Note that the threshold is set to a different value between the use range 71 and the non-use range, but may be set to a different value for each layer in the use range 71 or for each layer in the non-use range.

The discrimination unit 14 does not need to perform discrimination for all the layers included in the trained model, and may perform discrimination only for the layers in the use range 71. In other words, the discrimination unit 14 can determine the layer to which the parameter used for the target for evaluation of a noise influence to the intermediate output belongs, based on the rank of the parameter for each layer of the trained model. Thus, the computational cost related to discrimination can be reduced.

### Effect

FIG. 12 is a diagram showing a performance index value for each OOD detection method. The detection methods are classified into a method using a classification probability, a method using a Mahalanobis distance, a method using noise injection, and a method using a projected component. The method using the classification probability is a method of discriminating as to whether the monitoring target data is OOD data based on the classification probability, which is the final output when the monitoring target data is input to the trained model. The method using the Mahalanobis distance is disclosed in Non-patent Literature 1. The method disclosed in Non-patent Literature 1 refers to an intermediate output of a convolutional neural network model that has learned a classification task, approximates the intermediate output with a multivariate normal distribution, and evaluates a degree of deviation from a training data distribution based on the Mahalanobis distance. The Mahalanobis distance is a distance index obtained by normalizing the Euclidean distance between the average of the intermediate outputs obtained from the training data and the intermediate output of the monitoring target data by the variance. The method using the projected component is the method according to the present embodiment. AUROC and AUPR are indices representing the performance of detecting OOD data.

As shown in FIG. 12, the method disclosed in Non-patent Literature 1 using the Mahalanobis distance has higher detection performance than the method using the classification probability, and that the method using the projected component according to the present embodiment has substantially the same detection performance as the method disclosed in Non-patent Literature 1. The method of noise injection has a low detection performance compared to the method disclosed in Non-patent Literature 1 and the method using a projected component, but requires only very little memory usage as described later.

In the method disclosed in Non-patent Literature 1, it is necessary to hold a covariance matrix of an intermediate output of training data in order to calculate the Mahalanobis distance. In the case of a deep learning model of multi-class classification, it is necessary to hold a covariance matrix for each class, and the memory usage for the covariance matrix is enormous. When the number of dimensions of intermediate outputs input to the weight parameter is represented by din and the number of classes is represented by K, the computational cost of the Mahalanobis distance is represented by O(Kdᵢₙ_{²}). The increase in computational cost due to secondary factors such as the number of classes, the convolution kernel receptive field, and the feature map size can be several dozen times or more. Therefore, the method disclosed in Non-patent Literature 1 is difficult to use for OOD data detection in a device having a small memory capacity such as an edge device.

On the other hand, the method according to the present embodiment does not use the Mahalanobis distance and, in turn, does not use a covariance matrix. If projection is used instead to conduct an evaluation, a projection matrix is retained instead. The use of noise injection renders retention of a matrix unnecessary. The computational cost according to the present embodiment using the projection matrix is represented by O(dᵢₙ·dₒᵤₜ) where dₒᵤₜ is the number of dimensions of the intermediate output that is output by the weight parameter. As described above, in the method according to the present embodiment, there is no increase in the computational cost depending on the number of classes, and the number of output dimensions dₒᵤₜ is usually smaller than the number of input dimensions dᵢₙ, so that the reduction in the computational cost is marked. If noise injection is used, no additional memory is necessary and the method is therefore more memory efficient than the embodiment using a projection matrix. In addition, model compression can further reduce the number of output dimensions and reduce computational costs.

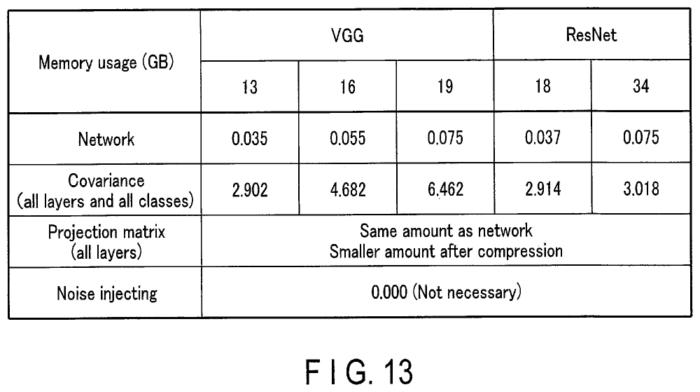

FIG. 13 is a diagram showing the memory usage of the method using the Mahalanobis distance and the method according to the present embodiment. VGG and ResNet are types of network structures of the deep learning model. The numbers 13, 16 and 19 in VGG and 18 and 34 in ResNet represent the number of layers. The “covariance” shown in FIG. 13 represents a covariance matrix used in the method according to Non-patent Literature 1, and a memory usage [GB] of the covariance matrix in each network structure is illustrated. The “projection matrix” represents a projection matrix used in the method according to the present embodiment.

As shown in FIG. 13, the memory usage of the “projection matrix” is substantially the same as the memory usage of the network, and is significantly smaller than the memory usage of the covariance matrix. If noise injection is used, the additional memory is not necessary. The memory usage of the “projection matrix” after model compression is further reduced.

Note that when the number of dimensions dₒᵤₜ′ of the intermediate outputs output by the weight parameters after model compression is set to about 0.2 dₒᵤₜ, optimum detection performance is obtained. The setting corresponds to a region where there is a significant decrease in classification accuracy associated with model compression. In other words, even when model compression is performed by pruning or other methods for reducing nodes that do not contribute to classification from a trained model, it is possible to maintain the detection performance of OOD data according to the present embodiment.

The projection matrix determination unit 12 may determine the size of the projection matrix in accordance with the memory capacity of the edge device by assuming that the detection processing of the OOD data is performed by the edge device. As described in the modification 2, the size of the projection matrix can be adjusted by increasing or decreasing the number of matrix components of the projection matrix.

As shown in FIGS. 12 and 13, the method according to the present embodiment can reduce the memory usage while maintaining the OOD data detection performance equivalent to that of the method according to Non-patent Literature 1. In the method according to the present embodiment, unlike the method according to Non-patent Literature 1, the training data distribution is not directly referred to, and only the parameter of the trained model is referred to. Since the method according to the present embodiment uses only information related to a training data distribution embedded in a trained model, a general-purpose aspect that can be generally used in a deep learning model is enhanced. The method according to the present embodiment can perform more general-purpose OOD data detection that does not depend on the details of the task of the trained model, and can reduce increases in the amount of computation and memory usage due to secondary factors such as the number of classification classes and the convolution kernel receptive field. Since the method according to the present embodiment is compatible with the compression of the deep learning model due to the nature of referring to the parameter of the trained model itself, a further memory reduction effect can be expected by using the method in combination with the model compression technique.

### Summarization

As described in some examples above, the OOD data detection apparatus 100 includes the obtainment unit 11, the intermediate output calculation unit 12, the noise influence evaluation unit 13, and the discrimination unit 14. The obtainment unit 11 obtains monitoring target data. The intermediate output calculation unit 12 calculates an intermediate output by applying a trained model to the monitoring target data. The noise influence evaluation unit 13 calculates a noise influence level of an intermediate output in a parameter constituting a trained model. The discrimination unit 14 discriminates as to whether the monitoring target data is OOD data based on the noise influence level.

According to the above configuration, it is possible to detect OOD data based on the noise influence level of the intermediate output to the parameter constituting the trained model. According to the method according to the present embodiment, it is possible to realize memory saving while achieving high detection performance of OOD data. Thus, OOD data can be detected with a low memory capacity.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An OOD detection apparatus comprising a processing circuit configured to:
obtain monitoring target data:
calculate an intermediate output by applying trained model to the monitoring target data;
calculate a noise influence level of the intermediate output in a parameter that constitutes the trained model; and
discriminate as to whether the monitoring target data is OOD data based on the noise influence level.

2. The OOD detection apparatus according to claim 1, wherein
the processing circuit is configured to calculate, as the noise influence level, a projected component of the intermediate output to a parameter constituting the trained model.

3. The OOD detection apparatus according to claim 2, wherein
the processing circuit is configured to:
determine a projection matrix based on a matrix decomposition of the parameter, and
calculate the projected component by making the projection matrix act on the intermediate output.

4. The OOD detection apparatus according to claim 3, wherein
the processing circuit is configured to calculate the projection matrix by performing singular value decomposition on a weight parameter constituting the trained model.

5. The OOD detection apparatus according to claim 3, wherein
the processing circuit is configured to delete a matrix component that has a low contribution to a task of the trained model among matrix components included in the projection matrix.

6. The OOD detection apparatus according to claim 5, wherein
the processing circuit is configured to search for a matrix component that satisfies a predetermined condition based on a change in a task performance of the trained model when positions and/or a number of matrix components included in the projection matrix are changed.

7. The OOD detection apparatus according to claim 1, wherein
the processing circuit is configured to:
convert the noise influence level to a one-dimensional variable for discrimination;
discriminate as to whether the monitoring target data is OOD data based on a comparison between the variable for discrimination and a threshold.

8. The OOD detection apparatus according to claim 7, wherein
the processing circuit is configured to set data not used for training the trained model among a plurality of training data sets to OOD data, and sets the threshold using the OOD data.

9. The OOD detection apparatus according to claim 8, wherein
the processing circuit is configured to set the threshold in such a manner that an outlier of the training data used for training the trained model can be classified into OOD data.

10. The OOD detection apparatus according to claim 7, wherein
the processing circuit is configured to calculate, as the variable for discrimination, a norm of the noise influence level or a ratio of a norm of the intermediate output to a norm of the noise influence level.

11. The OOD detection apparatus according to claim 7, wherein
the processing circuit is configured to:
determine a threshold for each layer of the trained model; and
discriminate as to whether the monitoring target data is OOD data based on a comparison between the variable for discrimination with the threshold for each layer.

12. The OOD detection apparatus according to claim 11, wherein
the processing circuit is configured to determine the threshold based on a rank of the parameter for each layer.

13. The OOD detection apparatus according to claim 1, wherein
the processing circuit is further configured to inject a noise to the intermediate output in an intermediate hidden layer of the trained model, wherein
the processing circuit has a degree-of-variation calculation unit configured to:
calculate a first intermediate output by applying a hidden layer later than the intermediate hidden layer to the intermediate output to which the noise is not injected;
calculate a second intermediate output by applying the later hidden layer to the intermediate output to which the noise is injected; and
calculate a degree of variation between the first intermediate output and the second intermediate output as the noise influence level.

14. An OOD detection method comprising:
obtaining monitoring target data;
calculating an intermediate output by applying a trained model to the monitoring target data;
calculating a noise influence level of the intermediate output in a parameter that constitutes the trained model; and
discriminating as to whether or not the monitoring target data is OOD data based on the noise influence level.

15. A non-transitory computer readable storage medium including computer executable instructions, wherein the instructions, when executed by a processor, cause the processor to perform operations comprising:
obtaining monitoring target data;
calculating an intermediate output by applying a trained model to the monitoring target data;
calculating a noise influence level of the intermediate output in a parameter that constitutes the trained model; and
discriminating as to whether the monitoring target data is OOD data based on the noise influence level.
